(19) United States
(12) Patent Application Publication
(10) Pub. No.: US 2014/0232156 A1
(43) Pub. Date: Aug. 21, 2014

(54) Pneumatic floor lift with transfer board

(71) Applicant: Jason Mills, Courtice (CA)

(72) Inventor: Jason Mills, Courtice (CA)

(21) Appl. No.: 13/999,365

(22) Filed: Feb. 18, 2014

(30) Foreign Application Priority Data
Feb. 18, 2013 (CA) 2806049

(51) Int. Cl. A61G 5/14; A61G 5/10

(52) U.S. Cl. CPC A61G 5/14; A61G 5/1059
USPC 297/338

(57) ABSTRACT

A number of bladders are stacked one upon another and in fluid flow communication with one another. A fluid introduced into one of the bladders causes that bladder and the remaining bladders to inflate with resulting increase in the height of the stack. An inflexible support panel is seated on top of the uppermost bladder. The panel may be attached to the uppermost bladder or may be detached from it. The panel has a flat upper surface which remains generally horizontal as the bladders inflate while the stack rests upon a flat horizontal surface.

This invention relates to lifting devices and more particularly to a device for elevating a disabled person from a prone position to a sitting or a standing position. The device also functions to lower a disabled person from an elevated position to a lower position.

This Application claims priority pursuant to 35 USC 119 of Canadian application no. 2,806,049 filed in the Canadian Intellectual Property Office on Feb. 18, 2013, the entire contents of which are hereby incorporated into the following application by reference.

In Canadian patent application no 2,549,793 to Davis pneumatic bladders are described for raising and lowering a disabled person from one position such as a prone position to another position such as a seated position or a standing position. A number of bladders are arranged one on top another in a stack and are in communication with one another by conduits so that air under pressure introduced into one bladder circulates throughout the remaining bladders and causes them all to inflate. The disabled person whose position is to be changed rests on the uppermost bladder in the stack and as the bladders inflate and deflate, the person rises or falls to allow him to change positions.

The Davis lifting device and ones like it have a number of shortcomings. The Davis device, for example, offers no support for top-down pressure when a disabled person is attempting to place himself on the lifting device or when he is attempting to get off it. If the stack of bladders is not fully inflated, when the person puts weight on his hand to help stabilize him as he moves on or off the lifting device, the bladders in the stack will feel spongy and his hand may move back and forth as he puts his weight on it. This is entirely unsatisfactory and unsafe for, if the person's hand is not stationary at this time, he will not be able to maintain his balance and he may fall over.

Another problem with the Davis lifting device is that if the person does not place his weight at the centre of the uppermost bladder in the stack of bladders, the stack may become unstable and tip over.

I have found that the shortcomings mentioned above can be overcome if a rigid, inflexible support panel is provided on the uppermost bladder in a stack. When the stack of bladders is flat or not fully inflated and a disabled person attempts to slide onto the support panel, The person can place his hand on the support panel to steady himself. His weight on the support panel will be distributed over the length of the support panel and movement of the support panel at this time will be minimal or nonexistent. As well, the weight of the person's posterior on the support panel will prevent the support panel from swinging upward when the person places his weight on his hand.

According to a preferred embodiment of my invention, pockets are provided in the uppermost bladder for receipt of the support panel so that the support panel is properly centered when the disable person places his weight on it. In addition, the upper wall is marked where the person should be seated and where his hands should be to further ensure that the disabled person is properly centered on the stack of bladders.

Briefly, the lifting device of my invention includes: a plurality of bladders stacked one upon another and in fluid flow communication with one another such that a gas introduced into one of the bladders causes the latter bladder and the remaining bladders in the stack to inflate with resulting increase in the height of the stack; and an inflexible support panel disposed on top of the uppermost bladder, the support panel having a flat upper surface which remains generally horizontal as the bladders inflate while the stack is disposed upon a generally horizontal surface.

The lifting device of the invention is described with reference to the accompanying drawings in which:

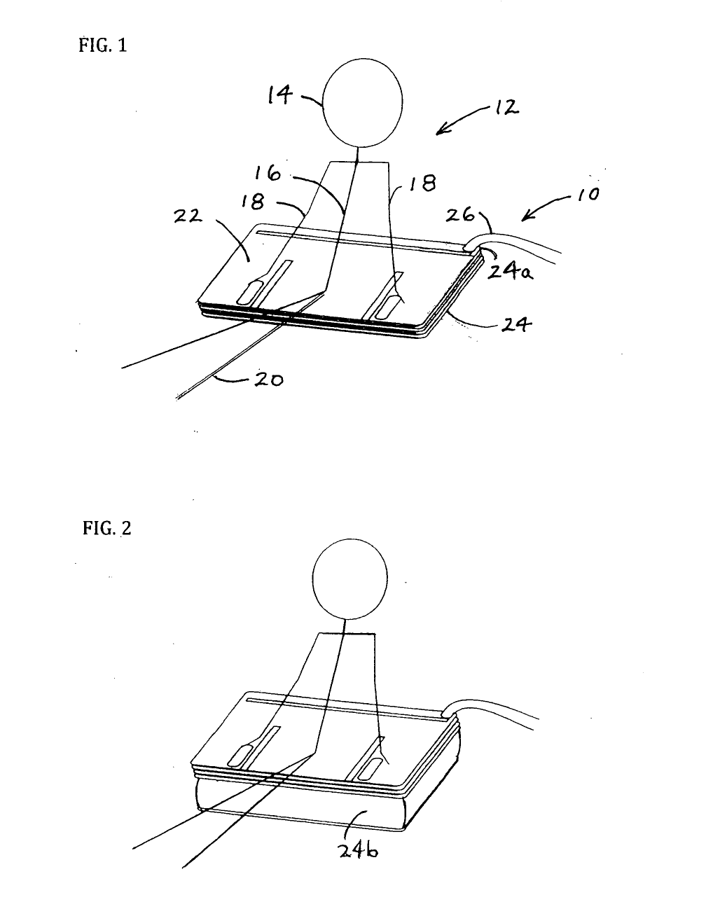

FIG. 1 is a perspective view of the lifting device when fully deflated together with a stick drawing of a person seated on the lifting device;

FIG. 2 is a perspective view of the lifting device as it begins to inflate;

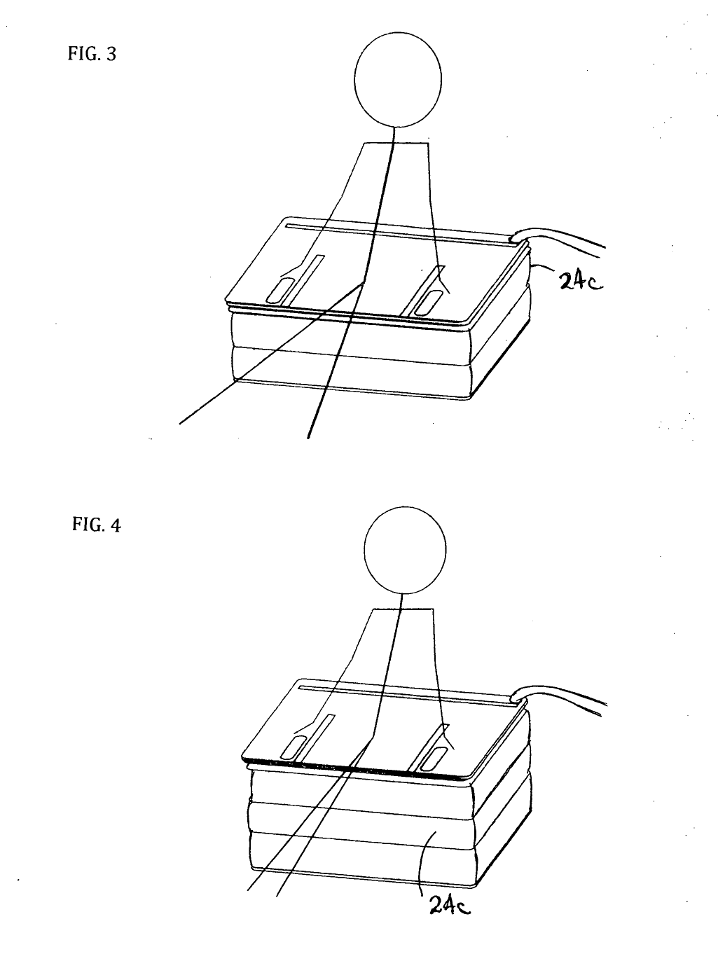

FIG. 3 is a perspective view of the lifting device as inflation of the bladders continues;

FIG. 4 is another perspective view of the lifting device as inflation continues further;

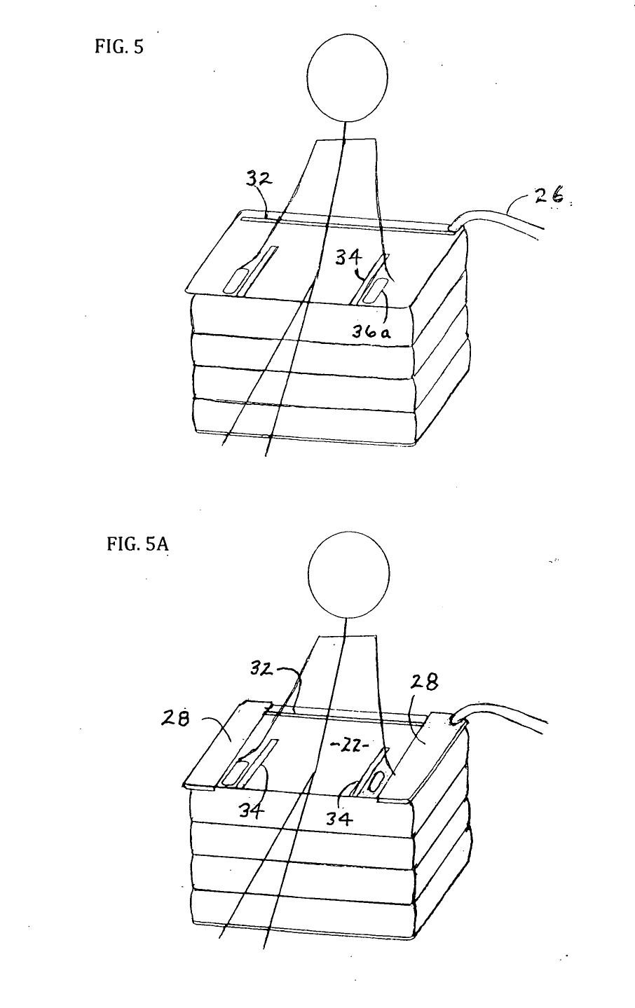

FIGS. 5 and 5A are a perspective views of the device when fully inflated. In FIG. 5A pockets are shown for immobilizing a support panel;

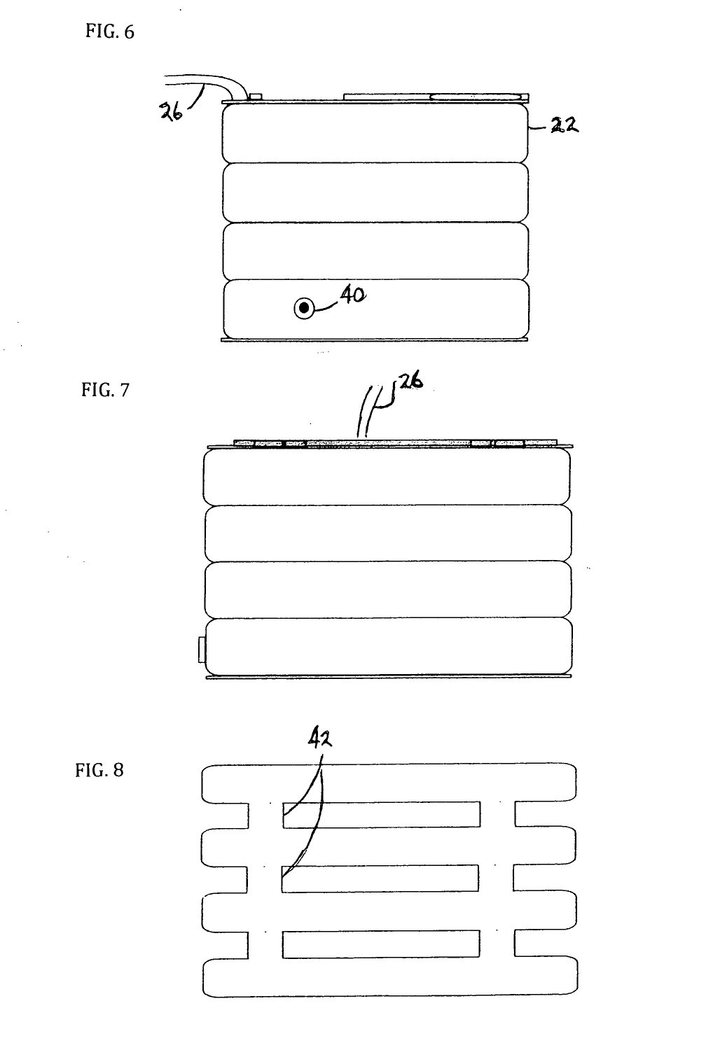

FIG. 6 is an elevation of the lifting device in a fully inflated state;

FIG. 7 is an elevation of the device rotated 90 degrees from the elevation illustrated in FIG. 6;

FIG. 8 is an elevation of the device shown schematically in which the passages for air or other fluid between the bladders which make up the device are shown in enlarged scale;

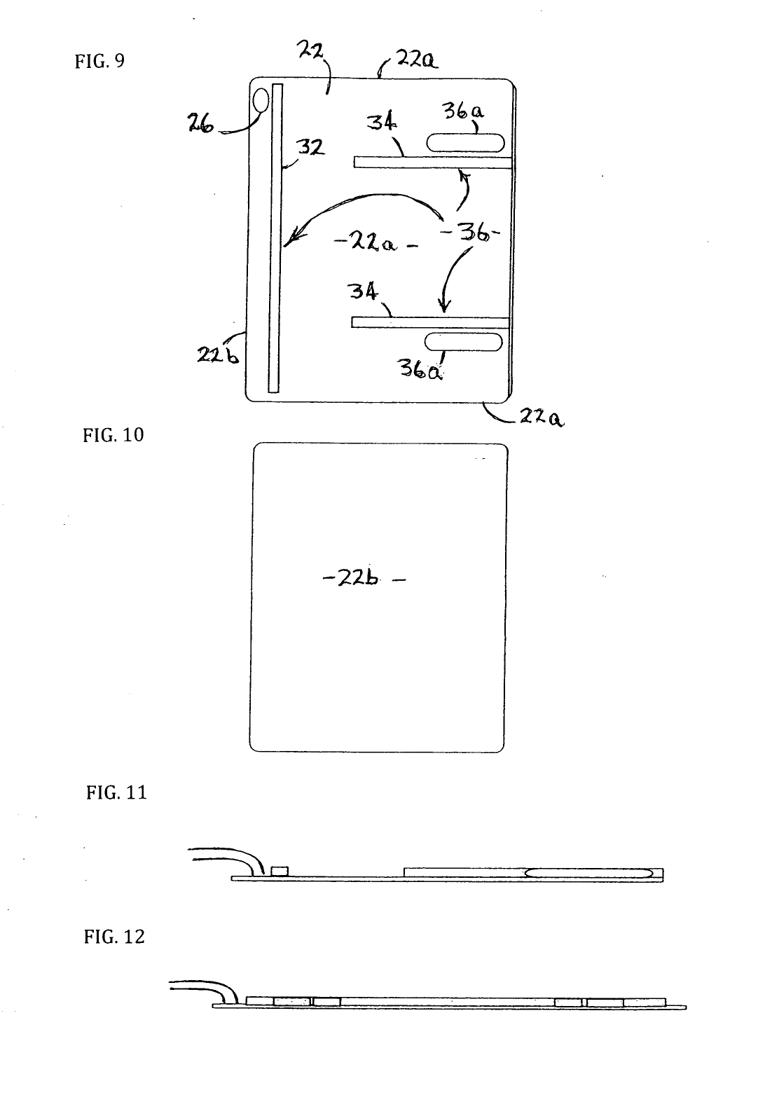

FIG. 9 is a view of the upper wall of the support panel;

FIG. 10 is a view of the bottom wall of the support panel;

FIG. 11 is a side view of a support panel; and

FIG. 12 is an elevation of the support panel rotated 90 degrees from the elevation illustrated in FIG. 11.

Like reference characters refer to like parts throughout the description of the drawings.

With reference to FIGS. 1 to 4, the lifting device of the invention, generally 10, is shown in conjunction with a person, generally 12 seated on the device. The person is shown as a stick figure having a head 14, torso 16, arms 18 and legs 20. The person is seated upon a support panel 22 which rests upon the uppermost bladder 24a in a stack of like bladders 24.

The bladders of the lifting device are seated one upon another and are in fluid flow communication with one another so that as air or other fluid under pressure is introduced into one bladder, that air or fluid circulates throughout the remaining bladders and causes all the bladders in the stack to inflate.

The air is introduced into the bladders through hose 26. Before reaching the bladders, the air is pressurized by conventional means such as an air compressor (not illustrated).

Throughout the following description, the air or other inflating fluid is referred to “inflating fluid” which may be, in addition to air other gases such as carbon dioxide or liquids such as water. In all cases the inflating fluid will be under relatively low pressure, sufficient to cause the bladders to inflate and to support a person seated on the stack of bladders but insufficient to injure the person in the event of leakage of the inflating fluid.

In FIG. 1, inflating fluid has been evacuated from all of the bladders and they are all flat. In FIG. 2, inflating fluid has been introduced into the lowermost bladder 24b through the hose which extends downward through the interior of the bladders and opens into the lowermost bladder. As the inflating fluid flows into the bladder, it inflates but the remaining bladders do not. In FIG. 3, the inflating fluid has filled both the lowermost bladder and the bladder 24c immediately above it and both bladders have inflated. In FIGS. 3 to 5 the remaining bladders in progression have inflated.

With reference to FIGS. 5a, 9 and 10, seated upon the uppermost bladder is support panel 22 upon which the person using the lifting device is seated. The support panel has flat upper and lower walls 22a, b, respectively and remains horizontal as the bladders inflate and deflate. Pockets 28 are preferably provided for removable receipt of the side margins of the support panel so that the support panel is immovable on the uppermost bladder and so that the support panel is properly centered on the bladder.

The support panel is preferably relative light so that it can be easily handled. To ensure that the support panel does not bend it is strengthened by a longitudinal reinforcing bar 32 and a pair of parallel lateral reinforcing bars 34. The panel may be composed of wood, plastic or other relatively strong and inflexible material.

The reinforcing bars are placed so that they define a space, generally 36, where the person being elevated should sit. To that end, each lateral bar 34 should be separated from one side edge 22a of the support panel a distance equal to that of the separation of the other lateral bar from the opposite side edge. The longitudinal bar 32 should preferably be located parallel to and adjacent to the rear edge 22b of the support panel. Areas on the support panel distinctively painted to represent, for example, hands can be provided adjacent to the lateral bars or elsewhere as an indication of where the person should place his hands when he is seating himself on the support panel so that his weight is located centrally on the support panel. Pads 36a can serve the same purpose.

With reference to FIGS. 6 and 7, bladders 22 in the stack are fully inflated. Hose 26 feeds compressed inflating fluid to the interior of the stack and a valve 40 is provided in the lowermost bladder from which inflating fluid discharges at a controlled rate when the lifting device is used to lower the person seated on it. In FIG. 8, conduits 42 interconnect adjacent bladders to allow inflating fluid introduced into the bladders to circulate through them.

It will be understood, of course, that modifications can be made in the structure of the lifting device of the invention without departing from the scope and purview of the invention as defined in the appended claims.

I claim:

1. A pneumatic lifting device for elevating a person from a seated position to a higher seated position or to a standing position including: a plurality of bladders stacked one upon another and in fluid flow communication with one another such that a fluid under pressure introduced into one of said bladders causes the latter said bladder and the remaining said bladders in said stack to inflate with resulting increase in the height of said stack; and a relatively inflexible support panel disposed upon said uppermost bladder, said support panel having an upper surface which remains generally horizontal as said bladders inflate while said stack is disposed upon a generally horizontal surface.

2. The lifting device of claim 1 further including a longitudinal reinforcing bar disposed upon said support panel for minimizing longitudinal buckling of said stack as the person seats himself upon and while the person is seated upon said support panel said bladders inflate.

3. The lifting device of claim 1 further including a pair of lateral reinforcing bars disposed at either side of said support panel for minimizing lateral buckling of said stack as the person seats himself upon and while the person is seated upon said support panel as said bladders inflate.

4. The lifting device of claim 1 further including a longitudinal reinforcing bar and a pair of lateral reinforcing bars disposed upon said support panel for minimizing longitudinal and lateral buckling, respectively, of said stack as the person seats himself upon and while the person is seated upon said support panel as said bladders inflate.

5. The lifting device of claim 1 wherein said support panel has oppositely facing side edges and oppositely facing front and back edges, said lifting device further including a pair of pockets within which said side edges are accommodated for minimizing movement of said support panel relative to said uppermost bladder.

6. The lifting device of claim 1 wherein said support panel has oppositely facing side edges and oppositely facing front and back edges, said lifting device further including a pair of pockets within which said front and back edges are accommodated for minimizing movement of said support panel relative to said uppermost bladder.

7. The lifting device of claim 1 further including areas on the support panel distinctively painted or covered by pads for indicating where the person should place his hands when he is seating himself on said support panel so that his weight is located centrally on said support panel.

8. A pneumatic lifting device for elevating a person from a seated position to a higher seated position or to a standing position including: a plurality of bladders stacked one upon another and in fluid flow communication with one another such that a fluid under pressure introduced into one of said bladders causes the latter said bladder and the remaining said bladders in said stack to inflate with resulting increase in the height of said stack; an uppermost of said bladders having an upper wall adapted to remain generally horizontal as said bladders inflate while said stack is disposed upon a generally horizontal surface; and a generally inflexible support panel disposed on top of said uppermost bladder, said support panel having a flat upper surface which remain generally horizontal as said bladders inflate.

9. The lifting device of claim 8 further including a longitudinal reinforcing bar disposed upon said support panel for minimizing longitudinal buckling of said stack as the person seats himself upon and while the person is seated upon said support panel said bladders inflate.

10. The lifting device of claim 8 further including a pair of lateral reinforcing bars disposed at either side of said support panel for minimizing lateral buckling of said stack as the person seats himself upon and while the person is seated upon said support panel as said bladders inflate.

11. The lifting device of claim 8 further including a longitudinal reinforcing bar and a pair of lateral reinforcing bars disposed upon said support panel for minimizing longitudinal and lateral buckling, respectively, of said stack as the person seats himself upon and while the person is seated upon said support panel as said bladders inflate.

12. The lifting device of claim 8 wherein said support panel has oppositely facing side edges and oppositely facing front and back edges, said lifting device further including a pair of pockets within which said side edges are accommodated for minimizing movement of said support panel relative to said uppermost bladder.

13. The lifting device of claim 8 wherein said support panel has oppositely facing side edges and oppositely facing front and back edges, said lifting device further including a pair of pockets within which said front and back edges are accommodated for minimizing movement of said support panel relative to said uppermost bladder.

14. The lifting device of claim 8 further including areas on the support panel distinctively painted or covered by pads for indicating where the person should place his hands when he is seating himself on said support panel so that his weight is located centrally on said support panel.
